(19) United States
(12) Patent Application Publication
(10) Pub. No.: US 2025/0374216 A1
(43) Pub. Date: Dec. 4, 2025

(54) TIMING ADVANCE REFINEMENT PROCEDURE

(71) Applicant: Nokia Technologies Oy, Espoo (FI)

(72) Inventors: Juha Pekka KARJALAINEN, Oulu (FI); Timo KOSKELA, Oulu (FI); Mihai ENESCU, Espoo (FI); Sami-Jukka HAKOLA, Oulu (FI); Bikshapathi GOUDA, Oulu (FI); Antti ARVOLA, Oulu (FI); Antti TÖLLI, Oulu (FI)

(21) Appl. No.: 18/996,671

(22) PCT Filed: May 15, 2023
(86) PCT No.: PCT/EP2023/062889

§ 371 Date: Jan. 17, 2025

(30) Foreign Application Priority Data
Aug. 12, 2022 (FI) 20225718

(51) Int. Cl. H04W 56/00; H04W 72/23; H04W 74/0833

(52) U.S. Cl. CPC H04W 56/0045; H04W 72/23; H04W 74/0833

(57) ABSTRACT

An apparatus may be configured to: receive a plurality of downlink resources, wherein the plurality of downlink resources are respectively associated with respective ones of a plurality of transmission and reception points of a network; determine a set of respective timing offset values, wherein respective ones of the determined set of respective timing offset values are associated with different respective ones of the plurality of downlink resources; generate a report based, at least partially, on the determined set of respective timing offset values; transmit the report to the network; and receive one or more timing advance values in response to the transmitted report.

### TECHNICAL FIELD

The example and non-limiting embodiments relate generally to cellular communication and, more particularly, to timing advance offsets.

### BACKGROUND

It is known, in cellular communication, to configure a user equipment with multiple timing advance groups.

### SUMMARY

The following summary is merely intended to be illustrative. The summary is not intended to limit the scope of the claims.

In accordance with one aspect, an apparatus comprising means for performing: receiving a plurality of downlink resources; determining one or more respective timing offset values, wherein respective ones of the one or more respective timing offset values are associated with different respective ones of the plurality of downlink resources; generating a report based, at least partially, on the one or more determined respective timing offset values; and transmitting the report to the network.

In accordance with one aspect, an apparatus comprising: at least one processor; and at least one memory storing instructions that, when executed by the at least one processor, cause the apparatus at least to: receive a plurality of downlink resources; determine one or more respective timing offset values, wherein respective ones of the one or more respective timing offset values are associated with different respective ones of the plurality of downlink resources; generate a report based, at least partially, on the one or more determined respective timing offset values; and transmit the report to the network.

In accordance with one aspect, a method comprising: receiving, with a user equipment, a plurality of downlink resources; determining one or more respective timing offset values, wherein respective ones of the one or more respective timing offset values are associated with different respective ones of the plurality of downlink resources; generating a report based, at least partially, on the one or more determined respective timing offset values; and transmitting the report to the network.

In accordance with one aspect, a non-transitory computer-readable medium comprising instructions stored thereon which, when executed with at least one processor, cause the at least one processor to: cause receiving of a plurality of downlink resources; determine one or more respective timing offset values, wherein respective ones of the one or more respective timing offset values are associated with different respective ones of the plurality of downlink resources; generate a report based, at least partially, on the one or more determined respective timing offset values; and cause transmitting of the report to the network.

In accordance with one aspect, an apparatus comprising means for performing: receiving, from a user equipment, a report; determining one or more timing advance values associated with respective ones of a plurality of corresponding downlink resources based, at least partially, on the report; and transmitting, to the user equipment, at least one of the one or more determined timing advance values.

In accordance with one aspect, an apparatus comprising: at least one processor; and at least one memory storing instructions that, when executed by the at least one processor, cause the apparatus at least to: receive, from a user equipment, a report; determine one or more timing advance values associated with respective ones of a plurality of corresponding downlink resources based, at least partially, on the report; and transmit, to the user equipment, at least one of the one or more determined timing advance values.

In accordance with one aspect, a method comprising: receiving, from a user equipment, a report; determining one or more timing advance values associated with respective ones of a plurality of corresponding downlink resources based, at least partially, on the report; and transmitting, to the user equipment, at least one of the one or more determined timing advance values.

In accordance with one aspect, a non-transitory computer-readable medium comprising instructions stored thereon which, when executed with at least one processor, cause the at least one processor to: cause receiving, from a user equipment, of a report; determine one or more timing advance values associated with respective ones of a plurality of corresponding downlink resources based, at least partially, on the report; and cause transmitting, to the user equipment, of at least one of the one or more determined timing advance values.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a flowchart illustrating steps as described herein; and

FIG. 9 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AMF access and mobility management function
CBRA contention based random access
CE control element
CFRA contention free random access
C-JT coherent joint transmission
CRAN cloud radio access network
CSI channel state information
CU central unit
D2D device-to-device
DCI downlink control information
DL downlink
DU distributed unit
eLCID extended logical channel ID
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
Evo evolution
FDD frequency division duplex
gNB (or gNodeB) base station for 5G/NR, i.e., a node providing NR user plane and control plane protocol terminations towards the UE, and connected via the NG interface to the 5GC
I/F interface
IoT Internet of Things
L1 layer 1
LCID logical channel ID
LTE long term evolution
MAC medium access control
MIMO multiple input multiple output
MME mobility management entity
M-TRP multiple transmission and reception points
ng or NG new generation
ng-eNB or NG-eNB new generation eNB
NR new radio
N/W or NW network
NZP-CSI-RS NZP channel state information reference signal
O-RAN open radio access network
PCI physical cell ID
PDCCH physical downlink control channel
PDCP packet data convergence protocol
PHY physical layer
PRACH physical random access channel
ProSe proximity service
RA random access
RAN radio access network
RAR random access response
RF radio frequency
RLC radio link control
RRC radio resource control
RRH remote radio head
RS reference signal
RU radio unit
Rx receiver
SDAP service data adaptation protocol
SGW serving gateway
SL sidelink
SMF session management function
SRI sounding reference signal resource indication
SRS sounding reference signal
SSB synchronization signal block
TA timing advance
TAC timing advance command
TAG timing advance group
TAI timing advance information
TAT time alignment timer
TCI transmission configuration indicator
TDD time division duplex
ToA time of arrival
TRP transmission and reception point
TRS time and frequency tracking reference signal
Tx transmitter
UE user equipment (e.g., a wireless, typically mobile device)
UL uplink
UPF user plane function
V2I vehicle to infrastructure
V2P vehicle to pedestrian
V2V vehicle to vehicle
V2X vehicle to everything
VNR virtualized network function

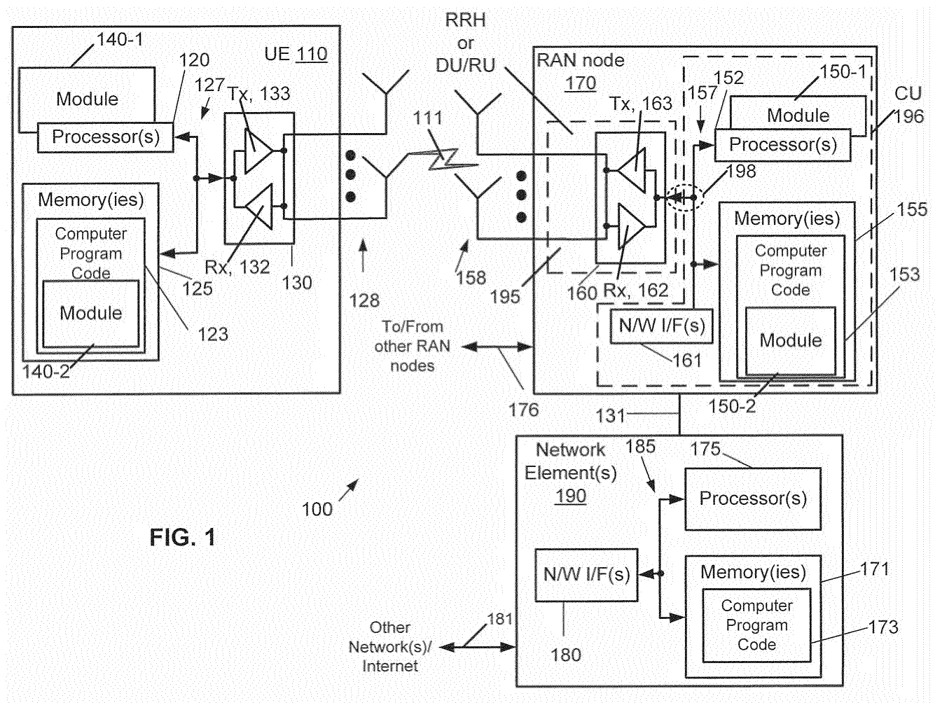

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The UE 110 may be capable of sidelink communication with other UEs in addition to network communication or if wireless communication with a network is unavailable or not possible. For example, the UE 110 may perform sidelink communication with another UE which may include some or all of the features of UE 110, and/or may include additional features. Optionally, the UE 110 may also communicate with other UEs via short range communication technologies, such as Bluetooth®.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUS) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. In addition, various embodiments of the user equipment 110 can include, but are not limited to, devices integrated into vehicles, infrastructure associated with vehicular travel, wearable devices used by pedestrians or other non-vehicular users of roads, user equipment unrelated to traffic users, and user equipment configured to participate in sidelink scenarios, such as public safety user equipment and/or other commercial user equipment.

Having thus introduced one suitable but non-limiting technical context for the practice of the example embodiments of the present disclosure, example embodiments will now be described with greater specificity.

Features as described herein generally relate to PHY layer enhancements. Features as described herein generally relate to new radio (NR) Rel-18 multiple input multiple output (MIMO) evolution (Evo) for downlink (DL) and uplink (UL) work item in RAN1. More specifically, features as described herein may relate to time division duplex (TDD) downlink DL coherent joint transmission (C-JT) with multiple transmission and reception points (M-TRPs) via uplink sounding, for example with sounding reference signal(s) (SRS), as well as M-TRP timing advance (TA) operation.

NR Rel-18 MIMO Evo DL UL is expected to specify support for TDD C-JT via UL SRS, as well as multi-TA operation, as follows:
“. . . RAN1:
Study, and if justified, specify the following
   Two TAs for UL multi-DCI for multi-TRP operation
   Power control for UL single DCI for multi-TRP operation where unified TCI framework extension in objective 2 is assumed.
For the case of simultaneous UL transmission from multiple panels, the operation will only be limited to the objective 6 scenarios . . . .
. . . Study, and if justified, specify enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, taking into account throughput-overhead trade-off
   SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences . . . .”

In current REL-17 specification, support for uplink timing advance adjustment is included. The primary target of the timing advance (TA) is to ensure that uplink transmissions from all UE are synchronized when received by the gNB. As a result of this, interference, e.g. inter-symbol interference, multi-user interference, etc., may avoided be between different signals/channels/reference signals between different UEs at the gNB receiver. TA is an offset, which the UE may use to advance its UL transmission in relation to the time where it receives DL transmission(s) from the base station. In other words, it is the offset at the UE between the start of a received downlink subframe and a transmitted uplink subframe.

A timing advance value may be updated with a medium access control (MAC) control element (CE), which may include a new TAvalue; the timeAlignmentTimer may then be restarted. If the timer expires, the UE may release UL configuration(s) for the cells in the group, and may need to perform a random access (RA) procedure before further uplink transmission(s) within a cell are possible.

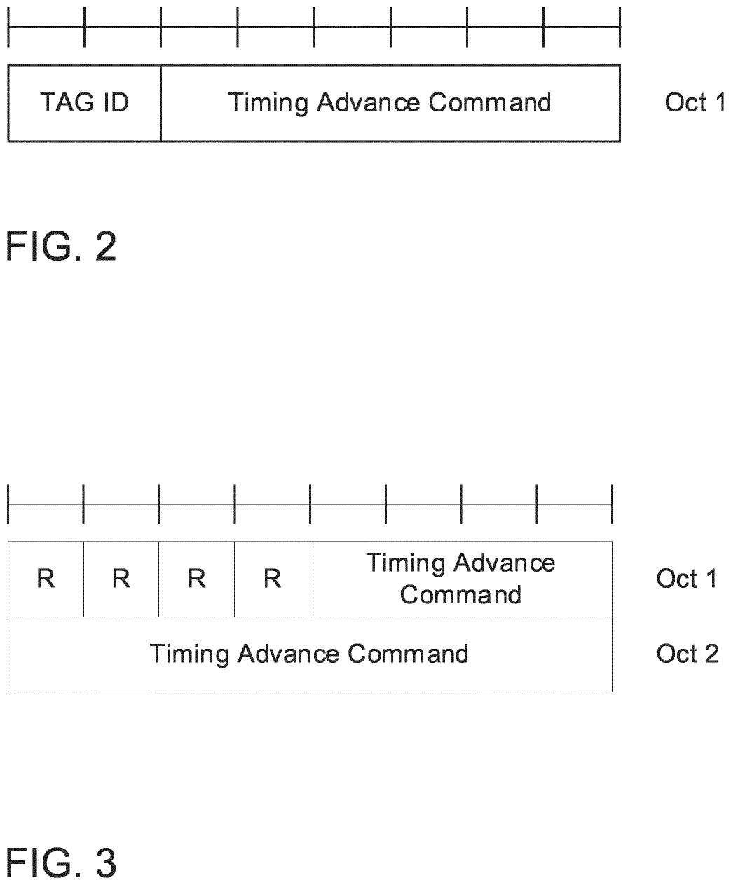

In [TS 38.321] Sect. 6.1.3.4, Timing Advance Command MAC CE, the timing advance command MAC CE is identified by a MAC subheader with a logical channel ID (LCID) as specified in Table 6.2.1-1. The timing advance command MAC CE, an example of which is illustrated in FIG. 2, has a fixed size and consists of a single octet, defined as follows:
“. . . . TAG Identity (TAG ID): This field indicates the TAG Identity of the addressed TAG. The TAG containing the SpCell has the TAG Identity 0. The length of the field is 2 bits;
Timing Advance Command: This field indicates the index value TA (0, 1, 2 . . . 63) used to control the amount of timing adjustment that MAC entity has to apply (as specified in TS 38.213 [6]). The length of the field is 6 bits . . . .”

In Sect. 6.1.3.4a, Absolute Timing Advance Command MAC CE, the absolute timing advance command MAC CE is identified by a MAC subheader with an eLCID as specified in Table 6.2.1-1b. The absolute timing advance command MAC CE, an example of which is illustrated in FIG. 3, has a fixed size and consists of two octets, defined as follows:
“. . . . Timing Advance Command: This field indicates the index value TA used to control the amount of timing adjustment that the MAC entity has to apply in TS 38.213 [6]. The size of the field is 12 bits;
R: Reserved bit, set to “0”. . . ”

The RAN1-109e agreements of Rel-18 WI MIMO Evo DL UL include the following:
“. . . Enhancement on two TAs for UL multi-DCI for multi-TRP operation is supported in Rel-18.
Note 1: whether (1) the network signals two TACs or (2) the network signals one TAC and the UE deriving the second TA can be further studied.
Note 2: evaluations can be considered on as-needed basis. . . .
. . . For multi-DCI based multi-TRP operation, down-select one of the two alternatives:
Alt 1: configure two TAGs within a serving cell
Alt 2: consider two TAs within one TAG within a serving cell . . . .
. . . Support two TA enhancement for both intra-cell and inter-cell multi-DCI multi-TRP scenarios in Rel-18.
For multi-DCI multi-TRP operation with two TAs, study the following alternatives:
Alt 1: two reference timings are considered
Alt 2: one reference timing is considered
Note: reference timing above is the timing of the DL reception . . . .

. . . For multi-DCI multi-TRP operation with two TAs, study the following alternatives further in Rel-18:
Alt 1: one n-TimingAdvanceOffset value per serving cell
Alt 2: two n-TimingAdvanceOffset value per serving cell . . . .”

The UE may obtain the UL timing advance (e.g. when it does not already have a TA) during a random access procedure. As an example, in the contention based random access (CBRA) procedure, the UE may transmit a random access preamble, and in a random access response (RAR), the network may provide the UE with an absolute timing advance command (TAC). To keep adjusting the timing advance, the network may periodically update the timing advance for the UE by sending additional TAC, which in turn may cause restart/start of the time alignment timer. In another example, in case of DL data arrival (and when the UE does not have a valid TA), the NW may trigger ‘a PDCCH order’ (a network initiated random access procedure) to cause the UE to perform a RA procedure. The triggered procedure may be a contention free random access (CFRA) procedure (with resources given in the DCI) or CBRA, depending on the transmitted/received PDCCH order.

Currently, the NR specification does not provide support for operation having multiple TA values per serving cell (in one serving cell, or in inter-cell beam management, or in M-TRP communication). The UE may be configured with multiple TA groups, and the groups may comprise one or more serving cells. However, for a single timing advance group (TAG), the UE may only maintain a single/same TA for each cell in the same TAG/cell group. In other words, only one TA value may be applied for all the uplink physical channels, signals, and reference signals (RS) in the cell, independent of propagation delay(s) associated with multiple TRPs.

Two different alternatives have been discussed to extend current TA operation for Rel-18 M-TRP operation. In the first alternative, two different TA values may be indicated for the UE. In the second alternative, only one TA value may be signaled for the UE, based on which the UE may derive the second TA value. However, despite above discussed TA operation enhancement(s), problems related to increased UL resource utilization, latency and/or interference (e.g. leading to degraded DL channel state information (CSI) quality) may arise for DL CSI acquisition for C-JT transmission with M-TRPs when UL SRS sounding with one or two TA values is used.

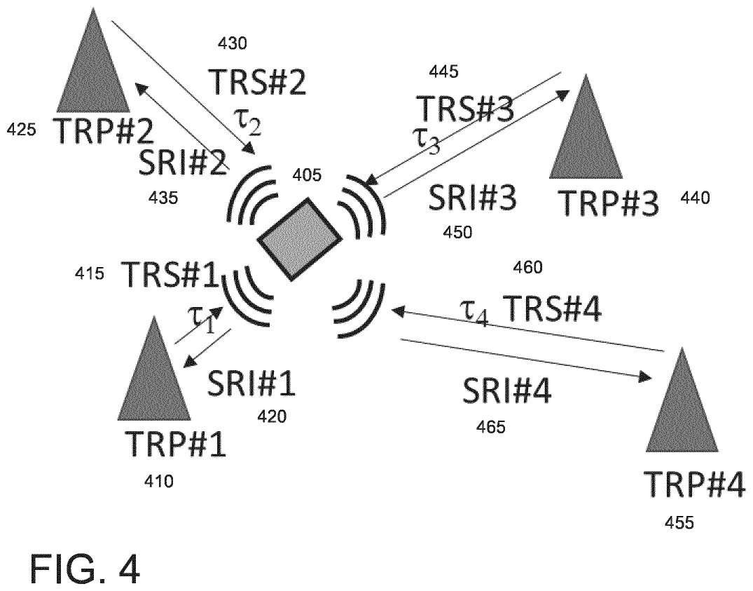

Referring now to FIG. 4, illustrated is an example M-TRP scenario with four TRPs associated with different propagation delays, where propagation delay τ₁, i=1 . . . 4, where τ₄>τ₃τ₁, is associated with each radio channel between TRP and the UE. The UE (405) may receive a downlink transmission of, for example, a reference signal TRS #1 (415) from TRP #1 (410) with a delay τ₁, and may transmit to TRP #1 (410) a sounding reference signal resource indication (SRI) SRI #1 (420). The UE (405) may receive TRS #2 (430) from TRP #2 (425) and may transmit to TRP #2 (425) SRI #2 (435). The UE (405) may receive TRS #3 (445) from TRP #3(440) and may transmit to TRP #3 (440) SRI #3 (450). The UE (405) may receive TRS #4 (460) from TRP #4 (455) and may transmit to TRP #4 (455) SRI #4 (465).

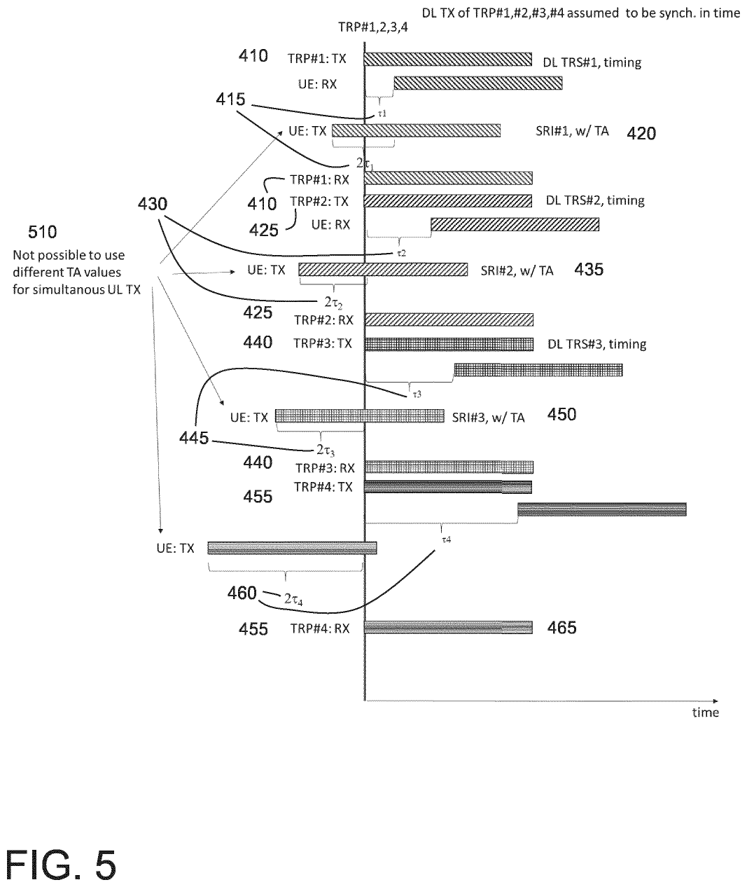

The UL timing advance diagram associated with FIG. 4 for UL transmission is shown in FIG. 5. As can be seen, four different UL SRS transmissions (420, 435, 450, 465) with different TA values may be required. Therefore, it may not be possible for the UE to transmit simultaneously in uplink to different TRPs (410, 425, 440, 455) with multiple TA values (510). As a result of this, the UL resource overhead, as well as latency associated with UL SRS transmission, may increase significantly with respect to usage of a single resource UL SRS transmission. The TRPs (410, 425, 440, 455) may belong to a same network entity (e.g. the TRPs may share a same physical cell ID (PCI)), or to different network entities (e.g. the TRPs may have different PCI), or some may belong to a same network entity while others belong to various other network entities.

In example embodiments of the present disclosure, new UE initiated and network based TA refinement procedure for Rel-18 may be implemented. A technical effect of example embodiments of the present disclosure may be to further enhance multi-TRP TA operation for TDD based DL C-JT via UL SRS sounding and/or UL C-JT or generic multi-TRP operation.

Example embodiments of the present disclosure may be applicable to sidelink UEs, for example in a scenario in which a network or cell switches off/on for a UE configured to perform sidelink (SL) operations. NR SL methods may be implemented to provide communication between a vehicle and a network, infrastructure(s), other vehicle(s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may relate to Internet of Things (IOT) and automotive industries (e.g., for reduction of accident risk and safer driving experiences). These use cases may include a message exchange among vehicles (V2V), vehicles and pedestrians (V2P), vehicles and infrastructure (V2I), and/or vehicles and networks (V2N), and may be referred to as vehicle-to-everything (V2X). The allocation of V2V resources in cellular, i.e., time and frequency resources, can be either controlled by the cellular network structure or performed autonomously by the individual vehicles (e.g. UE devices thereof). Sidelink may use same or different carrier frequencies or frequency bands than cellular communication.

In an example embodiment, a timing offset reporting procedure for UL timing advance refinement for DL CSI acquisition with M-TRP C-JT via UL SRS antenna switching (of the UE) or general for UL simultaneous transmission (including also multi-panel simultaneous TX with M-TRPs) may be implemented. In an example embodiment, a UL timing advance refinement procedure without PDCCH order may be implemented.

In an example embodiment, a timing offset reporting procedure may be enabled. In the present disclosure, the terms “timing offset,” “time offset,” and “timing offset value” may be used interchangeably; the use of any of these terms does not limit the applicability of another of these terms. A technical effect of example embodiments of the present disclosure may be to enable UL timing advance refinement for DL CSI acquisition with M-TRP C-JT via UL SRS antenna switching, and/or, in general, for UL simultaneous transmission (including also multi-panel simultaneous TX with M-TRPs).

In an example embodiment, a UE may be configured/indicated with a set of DL reference signal or synchronization signal block (SSB) resources, or joint/UL/DL TCI states, for UL timing advance refinement measurements at the UE-side. In an example embodiment, the DL resources or joint/UL/DL TCI states may be associated with TRPs (e. g. CORESETPool Index) from a serving and/or non-serving cell. For example, the DL resources or joint/UL/DL TCI states may be associated with NZP-CSI-RS for time and frequency tracking. In an example embodiment, one or more DL resources (i.e. DL RS or SSB resources) or joint/UL/DL TCI states may be configured as an anchor resource for the UL timing advance refinement measurements of/by the UE.

In an example embodiment, the UE may determine received timing offset values (i.e. propagation delays associated with a channel between a given TRP and the UE) based on the configured DL RS/SSB resource with respect to one or more configured anchor resource(s). In an example embodiment, the timing offset value of each resource may be associated with a “first path” of the power delay profile associated with the channel between the TRP and the UE. In an example embodiment, the “first path” of the power delay profile may be above a power threshold, Y, which may be configured by the network. Alternatively, in addition to the power threshold, the network may configure relative power offset(s) between different multipath components to distinguish the “first path.”

In an example embodiment, based on the determined timing offset value(s), the UE may determine relative timing offset values with respect to the configured anchor resource(s), and may select relative timing offset value(s) which fall into a refinement timing offset window. In an example embodiment, the UE may be configured with a refinement timing offset window, for example [−Tₓ, +Tₓ], where Tₓ may be configured by the network and may define time domain granularity in terms of time samples subject to a used numerology. In an example embodiment, when the UE is not configured with anchor resources, relative timing offset values may represent absolute timing offset values associated with each configured resource.

In an example embodiment, the timing advance refinement measurement report of the UE may consist of one or more of the following information: absolute timing offset value(s) associated with the configured anchor DL resource(s) or joint/UL/DL state(s) (e.g. in quantized form with, e.g., K-bits); relative timing offset value(s) for other DL resources/TCI states with respect to the anchor DL resource(s) or joint/UL/DL state(s) (e.g. in quantized form with, e.g., (L+1)-bits); and/or, the absolute and/or relative timing offset value(s).

In an example embodiment, the relative timing offset values with respect to the anchor DL resource(s) or the joint/UL/DL state(s) may exclude the relative timing offset value(s) between anchor resource(s) or joint/UL/DL TCI-state(s). In other words, if there are multiple anchor resources, then relative timing offset values between each of the multiple anchor resources may not be included; only relative timing offsets between each of the multiple anchor resources and non-anchor resources may be included.

In an example embodiment, when beam domain operation is used, Rel-17 capability value set index value reporting may be extended to include the absolute and/or relative timing offset value(s). In Rel-17 capability value set index reporting, the UE may measure DL SSB/NZP-CSI-RS resources and report N-best SSB/NZP-CSI-RS resources associated with UL TX capability set index. For example, a UE uplink single CSI reporting instance may consist of the following values, N=2: CRI #23, CRI #43, RSRP (#23), RSRP (#43), c-value-set-ind #2, c-value-set-ind #3. As a result of this UL CSI reporting, the network may have awareness of how many UL TX antenna ports are associated with some reported DL RSs associated with the UL SRS resources. Based on this, the network may configure/schedule a codebook-based UL SRS resource transmission at the time associated with single TRP.

In an example embodiment, one potential implementation of the M-TRP network deployment for DL joint coherent transmission may be with multiple TRPs having ideal/non-ideal backhaul network with synchronized carrier frequency on FR1 TDD carrier frequency (TDD FR2 operation not excluded). TRPs may be assumed to transmit DL signals/channel/reference signals in a phase aligned manner among different TRPs, defining a co-operative/active set, toward the UE.

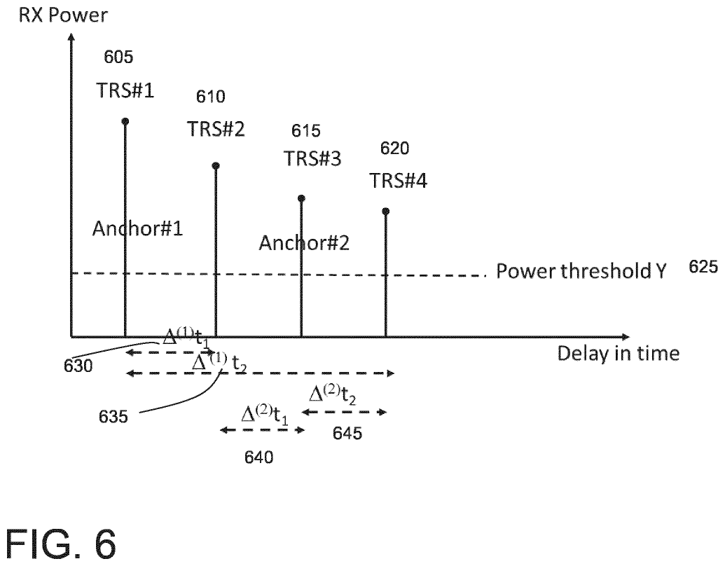

FIG. 6 illustrates, in an exemplary manner, an example UL TA refinement reporting procedure. The UE may be configured with four time and frequency reference signal (TRS) resources (605, 610, 615, 620), with two TRS resources as anchor resources (605, 615). Here, the TRS resources, which may be NZP-CSI-RS resources for time-frequency tracking (periodic/semi-persistent/aperiodic), may be associated with different TRPs via/using the CORESETSetPool index.

In an example embodiment, the UE may generate a timing advance refinement report. Upon reception of different single antenna port DL TRS resources, the UE may determine channel estimates associated with each antenna port. Based on the channel estimates, the UE may determine the time of arrival (ToA) of each multipath component (e.g. in the time domain) and may select, for each TRS resource, only one received power of ToA value associated with multipath component that is higher than a noise floor at the UE receiver, or higher or equal to a configured power threshold. When the UE is not configured with a power threshold value, the UE may use the noise floor at the UE receiver as a threshold to determine/select the ToA value for each multipath component. In the example of FIG. 6, a power threshold Y (625) may be configured. In the example of FIG. 6, each of TRS #1 (605), TRS #2 (610), TRS #3 (615), and TRS #4 (620) are illustrated to have a detected RX power above the power threshold Y (625). The TOA at which each TRS is received is illustrated along the x axis. However, this is not limiting; one or more DL resources may be below the power threshold Y (625), and may be disregarded as unreliable.

In the following, an example implementation to determine ToA of each multipath component is provided. As a first step, antenna port-specific channel estimates of TRS resource(s) may need to be determined at the UE side. To compute channel estimates, required TRS resource (NZP-CSI-RS for time-and frequency tracking) parameters (e.g. sequency initialization, resource allocation, comb-type, etc.) may have been preconfigured for the UE. Depending on the UE implementation, channel estimation may be done, e.g. in the frequency domain. Once antenna port specific channel estimates are obtained for the configured TRS measurement resources, the UE may compute reference signal received power (RSRP) for each TRS resource. Then, the UE may select TRS resources which are at or above some preconfigured power threshold. Then, frequency domain channel estimates of selected TRS resources may be converted into the time domain, where time domain channel estimates are available. Based on time-domain channel estimates, autocorrelation function of channel estimates may be computed to form a power delay presentation of channel estimates, which may represent different TOA values. Then, the UE may select TOA values which are, e.g., same or equal to, or greater than, the configured power threshold.

The UE may compute relative received time difference offsets between the selected ToA values, and the ToA value between the “anchor” TRS resources. In the example of FIG. 6, the anchor resources are TRS #1 (605) and TRS #3 (615). The UE may assume that the anchor resources are received at the UE side at the same or a higher received signal power with respect to other configured measurement resources. In an alternative implementation, the gNB may have configured a specific power threshold (i.e. 625); if the received reference signal power of the anchor resource is equal to or higher than the power threshold, the UE may be able to conduct reliable ToA measurement (as opposed to TOA measurement below an acceptable or predetermined level of reliability). The relative received time difference offset may be computed as follows for TRS #1 (605, anchor) and TRS #2 (610): Δ⁽¹⁾τ₁=τ₁−τ₂, where the τ₁ and τ₂ values may be associated with corresponding ToA values of the TRS resources. In the example of FIG. 6, the relative received timing difference offset between first anchor resource TRS #1 (605) and TRS #2 (610) is Δ⁽¹⁾τ₁ (630). The relative received time difference offset between TRS #1 (605) and TRS #4 (620) is Δ⁽¹⁾τ₂ (635). The relative received time difference offset between second anchor resource TRS #3 (615) and TRS #2 (610) is Δ⁽²⁾τ₁ (640). The relative received time difference offset between TRS #3 (615) and TRS #4 (620) is Δ⁽²⁾τ₂ (645). It may be noted that the UE may exclude relative timing offset computation of anchor resources, as well as their reporting. For example, the relative timing offset between TRS #1 (605) and TRS #3 (615) may not be computed or reported. Alternatively, relative timing offsets between anchor resources may not be reported by default, but may be reported based on an indication or configuration that reporting between different anchor resources should be reported; in such a case, the UE may also report timing difference values between anchor resources.

Relative received time difference offset values may be quantized with L-bits, where one additional bit may be reserved for the sign of the value, i.e. 0=−/negative and 1=+/positive, and ToA values of the anchor resources may be quantized with K-bits. The UE may provide a TA refinement report periodically/semi-persistently/aperiodically via upper layer radio signaling (e.g. L1 or L2 or L3). The TA refinement report may include one or more of the following information: the first DL reference signal/TCI state anchor resource absolute ToA value, τ⁽¹⁾, quantized with K-bits; the first relative received timing offset value, Δ⁽¹⁾τ₁, quantized with L-bits with respect to the DL first anchor reference signal/TCI state resource; the second relative received timing offset value, Δ⁽¹⁾τ₂, quantized with L-bits with respect to the first DL anchor reference signal/TCI state resource; the second DL reference signal/TCI state anchor resource absolute ToA value, τ⁽²⁾, quantized with K-bits; the first relative received timing offset value, Δ⁽²⁾τ₁, quantized with L-bits with respect to the DL second anchor reference signal/TCI state resource; and/or the second relative received timing offset value, Δ⁽²⁾τ₂, quantized with L-bits with respect to the second DL anchor reference signal/TCI state resource. In the example of FIG. 6, the report may be in the following format: τ⁽¹⁾, Δ⁽¹⁾τ₁, Δ⁽¹⁾τ₂, τ⁽²⁾, Δ⁽²⁾τ₁, Δ⁽²⁾τ₂. However, this format is not limiting; other formats including the relevant information may be possible.

In an example embodiment, one or more of the timing offset values reported by the UE may be considered a candidate timing advance value for uplink transmission. In other words, a reported timing offset value may be selected by the gNB and returned to the UE as a timing advance.

A person of ordinary skill in the art will understand that one, some, or all of these steps may be performed concurrently with each other.

In an example embodiment, based on the uplink TA refinement report, the gNB may determine two different TA values to be indicated via MAC- or L1-level signaling, for the UE to apply with uplink RS/signal/channel transmission with, for example, two different TA values with different TRPs. For example, TA values may be selected from the report.

In an example embodiment, the UE may report timing offsets for each anchor DL resource(s) and/or anchor joint/UL/DL TCI state(s), and/or for non-anchor DL resources, and/or non-anchor joint/UL/DL state(s), where only a single timing offset value may be applied for simultaneous UL transmissions with or without a multi-panel transmission capability. Additionally, a single timing offset value may be reported for each configured anchor resource/TCI state. In an example embodiment, the single timing offset value may represent the timing advance offset value that the UE may use for simultaneous UL transmission of reported timing offset measurement resources. In an example embodiment, the reported single timing offset value may fulfill one or more power threshold and/or timing offset window condition(s). For example, the UE may be configured with four DL TRS resources #1, . . . #4, where TRS #1 may be configured as the anchor resource for the timing offset measurements. The UE may report a single timing offset value, τ₁, with TRS resource #1, TRS resource #2, TRS resource #3 all/each having a timing offset value of 0 (i.e. indicating that measurements for those resources are not considered to be valid and/or reliable and/or having a quality defined by a configured power threshold). It may be noted that a ‘zero’ value among resources may define the reported timing offset to be invalid with/for TRS resource #4.

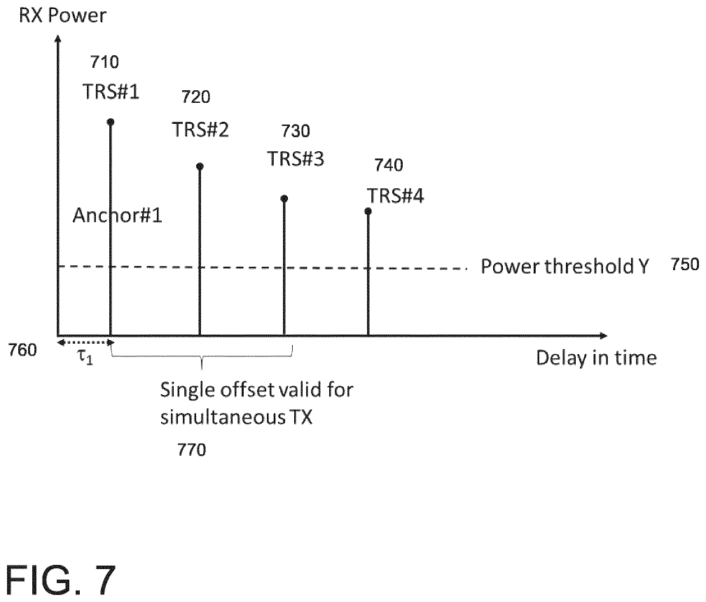

FIG. 7 illustrates, in an exemplary manner, an example of UL TA refinement reporting procedure for simultaneous uplink transmission with a single timing offset with corresponding TRS resource. The UE may be configured with four TRS resources (710, 720, 730, 740), with one TRS resource as the anchor resource (710). The TRS resources, for example NZP-CSI-RS resources for time-frequency tracking (periodic/semi-persistent/aperiodic), may be associated with different TRPs via a CORESETSetPool index.

In an example embodiment, the timing advance refinement report for simultaneous uplink transmission may be generated. Upon reception of the different single antenna port DL TRS resources, the UE may determine channel estimates associated with each antenna port of the configured/indicated resource/TCI-states. Based on the channel estimates, the UE may determine time of arrival (ToA) of each multipath component (in time and/or frequency domain) and may select, for each TRS resource, only one ToA value that is above the noise floor or configured power threshold (e.g. power threshold Y (750)). The UE may compute relative timing offset(s) between selected ToA values and the ToA value of the “anchor” TRS resource. In the example of FIG. 7, each of TRS #1 (710), TRS #2 (720), TRS #3 (730), and TRS #4 (740) are illustrated to have a detected RX power above the power threshold Y (750). The timing offsets are illustrated along the x-axis of FIG. 7.

The UE may select a single relative timing offset value, with respect to anchor resource/TCI-state, which may represent the timing advance offset value that the UE may use for simultaneous UL transmission of selected DL resources/TCI-states. For example, in FIG. 7, the UE may determine that simultaneous UL transmission is possible for anchor TRS #1 (710) and TRS #3 (730) with a single offset (770). The timing offset value for anchor TRS #1 (710) may be τ⁽¹⁾.

The relative received time difference offset values may be quantized with L-bits, where one additional bit may be reserved for the sign of the value, i.e. 0=−/negative and 1=+/positive, and the ToA values of the anchor resource(s) may be quantized with K-bits.

The UE may provide, simultaneously, an uplink TX TA refinement report periodically/semi-persistently/aperiodically via upper layer radio signaling (e.g. L1 or L2 or L3). The report may include the following information: the anchor DL reference signal/TCI state anchor resource absolute ToA value, τ⁽¹⁾, quantized with K-bits; the relative received timing offset value, Δ⁽¹⁾τ₁, quantized with L-bits with respect to the DL first anchor reference signal/TCI state resource; and/or a list of DL reference signal resources or TCI-states over which reported single TA may be applied for simultaneous uplink transmission (e.g. TRS #2 (720), TRS #3 (730)).

A person of ordinary skill in the art will understand that one, some, or all of these steps may be performed concurrently with each other.

In an example embodiment, a TA refinement procedure without usage of a PDCCH order may be defined. The UE may be configured with multiple TA reference resources (e.g. TRS)/TCI states. Association between a (received) reference resource and the PRACH preambles may be preconfigured. Upon reception of DL resource, the UE may transmit the UL PRACH preamble associated with the received DL resource(s). In beam domain operation, beam correspondence between DL RX and UL TX may be assumed. Upon reception of the UL PRACH preamble resource(s), the gNB may indicate, to the UE, a timing advance value(s), as well as corresponding DL resource(s) according to which the TA value(s) may be determined.

In an example embodiment, for the indicated DL reference signals for enabling UL TA refinement, the UE may be configured with one or more (unified) TCI states. The TCI state ID(s) may be activated for TA refinement measurements, for example as described herein, using a MAC CE (or RRC/DCI). The MAC CE may contain one or more TCI state IDs. The UE, based on the TCI states (e.g. the RS indicated by the TCI state) listed in the MAC CE, may determine the timing offset values with respect to the reference RS indicated via TCI state(s). The reference RS may be explicitly indicated; for example, one or more TCI states in the MAC CE may be tagged or associated with an indication that the specific TCI state is to be used as a reference. The indication may be a one bit flag/tag associated with the TCI state index field. The reference RS may also be separately configured. Based on the listed TCI states and the indicated reference TCI state (or states) in the MAC CE (e.g. there may be one or more reference values indicated in the MAC CE), the UE may determine the timing offset values (as described herein) with respect to the one or more indicated references.

A technical effect of example embodiments of the present disclosure may be to enable reduction of the number of UL SRS resource usage (reducing UL resource overhead).

A technical effect of example embodiments of the present disclosure may be to provide support for both TRP specific (multiple TA values) and single TA (common TA value for set of TRPs).

A technical effect of example embodiments of the present disclosure may be to enable identification of DL resources/TCI states that may be used for simultaneous uplink transmission with or without beam domain operation.

A technical effect of example embodiments of the present disclosure may be to enable UE friendly implementation (e.g. no need to use multiple TA values at the UE-side).

A technical effect of example embodiments of the present disclosure may be to enable to reduce uplink SRS resource overhead, as well as latency, in the context of UL SRS antenna switching for DL C-JT.

A technical effect of example embodiments of the present disclosure may be to improve cooperation between the NW and UE in the context of resource management (i.e. which UL resources associated with the reported DL resources may be used for simultaneous multi-antenna port/panel transmission).

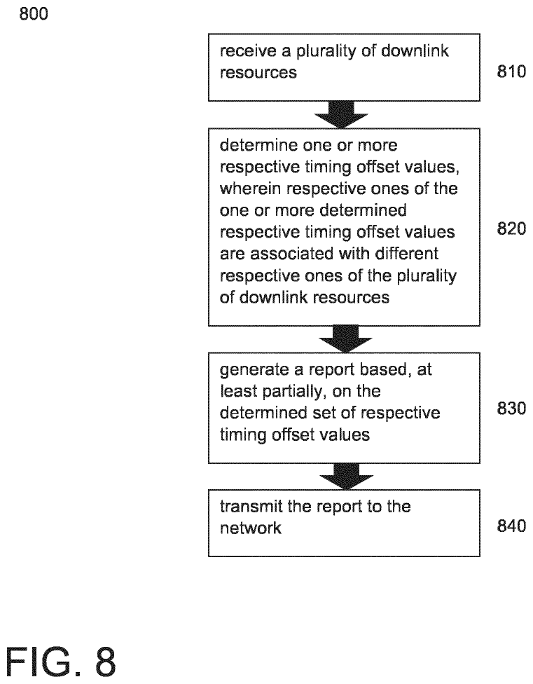

FIG. 8 illustrates the potential steps of an example method 800. The example method 800 may include: receiving a plurality of downlink resources, 810; determining one or more respective timing offset values, wherein respective ones of the one or more determined respective timing offset values are associated with different respective ones of the plurality of downlink resources, 820; generating a report based, at least partially, on the one or more determined respective timing offset values, 830; and transmitting the report to the network, 840. The example method 800 may be performed, for example, with a UE.

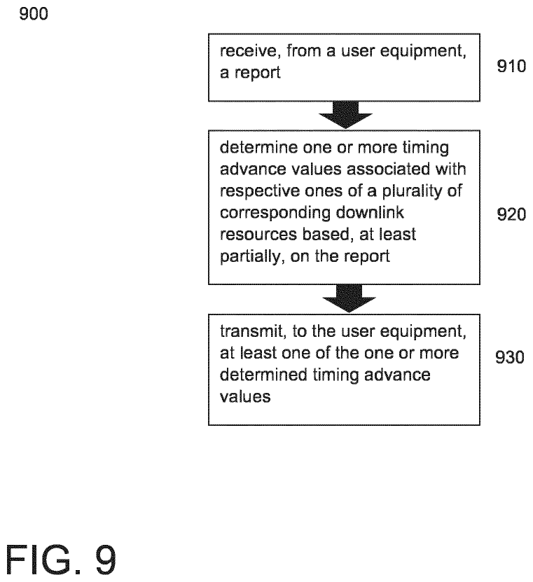

FIG. 9 illustrates the potential steps of an example method 900. The example method 900 may include: receiving, from a user equipment, a report, 910; determining one or more timing advance values associated with respective ones of a plurality of corresponding downlink resources based, at least partially, on the report, 920; and transmitting, to the user equipment, at least one of the one or more determined timing advance values, 930. The example method 900 may be performed, for example, with a base station or other network entity.

In accordance with one example embodiment, an apparatus may comprise: at least one processor; and at least one memory storing instructions that, when executed by the at least one processor, cause the apparatus at least to: receive a plurality of downlink resources; determine one or more respective timing offset values, wherein respective ones of the one or more respective timing offset values may be associated with different respective ones of the plurality of downlink resources; generate a report based, at least partially, on the one or more determined respective timing offset values; and transmit the report to the network.

The report may comprise a timing advance refinement report.

The plurality of downlink resources may be respectively associated with respective ones of a plurality of transmission and reception points of a network.

The example apparatus may be further configured to: receive one or more timing advance values.

Receiving the one or more timing advance values may comprise the example apparatus being configured to: receive the one or more timing advance values in response to the transmitted report.

The example apparatus may be further configured to: transmit, to the network, at least one uplink message using at least one of the one or more timing advance values.

Generating the report may comprise the example apparatus being configured to: determine at least one first timing offset value associated with a first downlink reference signal associated with one of the plurality of downlink resources; and determine at least one second timing offset value associated with a second downlink reference signal associated with another one of the plurality of downlink resources.

Generating the report may comprise the example apparatus being configured to: include an indication of the at least one first timing offset value and an indication of the at least one second timing offset value in the report.

At least one of: the at least one first timing offset value, or the at least one second timing offset value may comprise a candidate timing advance value for uplink transmission.

The plurality of downlink resources may comprise at least one of: a plurality of downlink reference signals, a plurality of synchronization signal block resources, downlink resources indicated by a plurality of joint downlink and uplink transmission configuration indicator states, downlink resources indicated by a plurality of downlink transmission configuration indicator states, or downlink resources indicated by a plurality of uplink transmission configuration indicator states.

The plurality of downlink resources may comprise at least one anchor resource, wherein determining the one or more respective timing offset values may comprise the example apparatus being configured to: determine respective relative timing offset values for the respective ones of the plurality of downlink resources relative to a timing offset value associated with the at least one anchor resource, wherein the respective relative timing offset values may be associated with a first path of one or more power delay profiles associated with the plurality of downlink resources, wherein the first path may be above a configured power threshold; determine or more of the respective relative timing offset values that may be within a timing window; and generate the report based, at least partially, on the timing offset value associated with the at least one anchor resource, and the determined one or more of the respective relative timing offset values.

The one or more determined respective timing offset values may comprise one or more absolute timing offset values.

The report may comprise an indication of a single timing offset value for simultaneous uplink transmission associated with at least two of the plurality of downlink resources, wherein the single timing offset value may be at least one of: a timing offset value associated with a downlink resource or resources, or a timing offset value associated with a downlink resource or resources having signal quality equal to or higher than a received power threshold, or a timing offset value associated with a downlink resource or resources within a timing offset window.

Determining the one or more respective timing offset values may comprise the example apparatus being configured to: receive an indication of at least one of: the plurality of downlink resources, or at least one reference resource of the plurality of downlink resources, wherein the indication may comprise at least one of: a medium access control element, a radio resource control downlink control information, or a physical layer control information.

Determining the one or more respective timing offset values may comprise the example apparatus being configured to: determine channel estimates for respective ones of the plurality of downlink resources; determine time of arrival values based, at least partially, on the determined channel estimates, wherein the determined time of arrival values may comprise values that are at least one of: equal to or above at least one of: a noise floor, or a received power threshold; and determine relative timing offset values between selected ones of the time of arrival values, wherein the one or more determined respective timing offset values may comprise the determined relative timing offset values.

The example apparatus may be further configured to: determine a random access preamble associated with at least one of the plurality of downlink resources; and transmit the determined random access preamble.

In accordance with one aspect, an example method may be provided comprising: receiving, with a user equipment, a plurality of downlink resources; determining one or more respective timing offset values, wherein respective ones of the one or more respective timing offset values may be associated with different respective ones of the plurality of downlink resources; generating a report based, at least partially, on the one or more determined respective timing offset values; and transmitting the report to the network.

The plurality of downlink resources may be respectively associated with respective ones of a plurality of transmission and reception points of a network.

The example method may further comprise: receiving one or more timing advance values.

The receiving of the one or more timing advance values may comprise: receiving the one or more timing advance values in response to the transmitted report.

The example method may further comprise: transmitting, to the network, at least one uplink message using at least one of the one or more timing advance values.

The generating of the report may further comprise: determining at least one first timing offset value associated with a first downlink reference signal associated with one of the plurality of downlink resources; and determining at least one second timing offset value associated with a second downlink reference signal associated with another one of the plurality of downlink resources.

The generating of the report may further comprise: including an indication of the at least one first timing offset value and an indication of the at least one second timing offset value in the report.

At least one of: the at least one first timing offset value, or the at least one second timing offset value may comprise a candidate timing advance value for uplink transmission.

The plurality of downlink resources may comprise at least one of: a plurality of downlink reference signals, a plurality of synchronization signal block resources, downlink resources indicated by a plurality of joint downlink and uplink transmission configuration indicator states, downlink resources indicated by a plurality of downlink transmission configuration indicator states, or downlink resources indicated by a plurality of uplink transmission configuration indicator states.

The plurality of downlink resources may comprise at least one anchor resource, wherein the determining of the one or more respective timing offset values may comprise: determining respective relative timing offset values for the respective ones of the plurality of downlink resources relative to a timing offset value associated with the at least one anchor resource, wherein the respective relative timing offset values may be associated with a first path of one or more power delay profiles associated with the plurality of downlink resources, wherein the first path may be above a configured power threshold; determining or more of the respective relative timing offset values that may be within a timing window; and generating the report based, at least partially, on the timing offset value associated with the at least one anchor resource, and the determined one or more of the respective relative timing offset values.

The one or more determined respective timing offset values may comprise one or more absolute timing offset values.

The report may comprise an indication of a single timing offset value for simultaneous uplink transmission associated with at least two of the plurality of downlink resources, wherein the single timing offset value may be at least one of: a timing offset value associated with a downlink resource or resources, a timing offset value associated with a downlink resource or resources having signal quality equal to or higher than a received power threshold, or a timing offset value associated with a downlink resource or resources within a timing offset window.

The determining of the one or more respective timing offset values may comprise: receiving an indication of at least one of: the plurality of downlink resources, or at least one reference resource of the plurality of downlink resources, wherein the indication may comprise at least one of: a medium access control element, a radio resource control downlink control information, or a physical layer control information.

The determining of the one or more respective timing offset values may comprise: determining channel estimates for respective ones of the plurality of downlink resources; determining time of arrival values based, at least partially, on the determined channel estimates, wherein the determined time of arrival values may comprise values that are at least one of: equal to or above at least one of: a noise floor, or a received power threshold; and determining relative timing offset values between selected ones of the time of arrival values, wherein the one or more determined respective timing offset values may comprise the determined relative timing offset values.

The example method may further comprise: determining a random access preamble associated with at least one of the plurality of downlink resources; and transmitting the determined random access preamble.

In accordance with one example embodiment, an apparatus may comprise: circuitry configured to perform: receiving, with a user equipment, a plurality of downlink resources; circuitry configured to perform: determining one or more respective timing offset values, wherein respective ones of the one or more respective timing offset values may be associated with different respective ones of the plurality of downlink resources; circuitry configured to perform: generating a report based, at least partially, on the one or more determined respective timing offset values; and circuitry configured to perform: transmitting the report to the network.

In accordance with one example embodiment, an apparatus may comprise: processing circuitry; memory circuitry including computer program code, the memory circuitry and the computer program code configured to, with the processing circuitry, enable the apparatus to: receive a plurality of downlink resources; determine one or more respective timing offset values, wherein respective ones of the one or more respective timing offset values may be associated with different respective ones of the plurality of downlink resources; generate a report based, at least partially, on the one or more determined respective timing offset values; and transmit the report to the network.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving a plurality of downlink resources; determining one or more respective timing offset values, wherein respective ones of the one or more respective timing offset values may be associated with different respective ones of the plurality of downlink resources; generating a report based, at least partially, on the one or more determined respective timing offset values; and transmitting the report to the network.

The plurality of downlink resources may be respectively associated with respective ones of a plurality of transmission and reception points of a network.

The means may be further configured to perform: receiving one or more timing advance values.

The means configured to perform receiving the one or more timing advance values may comprise means configured to perform: receiving the one or more timing advance values in response to the transmitted report.

The means may be further configured to perform: transmitting, to the network, at least one uplink message using at least one of the one or more timing advance values.

The means configured to perform generating the report may be further configured to perform: determining at least one first timing offset value associated with a first downlink reference signal associated with one of the plurality of downlink resources; and determining at least one second timing offset value associated with a second downlink reference signal associated with another one of the plurality of downlink resources.

The means configured to perform generating the report may be further configured to perform: including an indication of the at least one first timing offset value and an indication of the at least one second timing offset value in the report.

At least one of: the at least one first timing offset value, or the at least one second timing offset value may comprise a candidate timing advance value for uplink transmission.

The plurality of downlink resources may comprise at least one of: a plurality of downlink reference signals, a plurality of synchronization signal block resources, downlink resources indicated by a plurality joint downlink and uplink of transmission configuration indicator states, downlink resources indicated by a plurality of downlink transmission configuration indicator states, or downlink resources indicated by a plurality of uplink transmission configuration indicator states.

The plurality of downlink resources may comprise at least one anchor resource, wherein the means configured to perform determining the one or more respective timing offset values may comprise means configured to perform: determining respective relative timing offset values for the respective ones of the plurality of downlink resources relative to a timing offset value associated with the at least one anchor resource, wherein the respective relative timing offset values may be associated with a first path of one or more power delay profiles associated with the plurality of downlink resources, wherein the first path may be above a configured power threshold; determining or more of the respective relative timing offset values that are within a timing window; and generating the report based, at least partially, on the timing offset value associated with the at least one anchor resource, and the determined one or more of the respective relative timing offset values.

The one or more determined respective timing offset values may comprise one or more absolute timing offset values.

The report may comprise an indication of a single timing offset value for simultaneous uplink transmission associated with at least two of the plurality of downlink resources, wherein the single timing offset value may be at least one of: a timing offset value associated with a downlink resource or resources, a timing offset value associated with a downlink resource or resources having signal quality equal to or higher than a received power threshold, or a timing offset value associated with a downlink resource or resources within a timing offset window.

The means configured to perform determining the one or more respective timing offset values may comprise means configured to perform: receiving an indication of at least one of: the plurality of downlink resources, or at least one reference resource of the plurality of downlink resources, wherein the indication may comprise at least one of: a medium access control element, a radio resource control downlink control information, or a physical layer control information.

The means configured to perform determining the one or more respective timing offset values may comprise means configured to perform: determining channel estimates for respective ones of the plurality of downlink resources; determining time of arrival values based, at least partially, on the determined channel estimates, wherein the determined time of arrival values may comprise values that are at least one of: equal to or above at least one of: a noise floor, or a received power threshold; and determining relative timing offset values between selected ones of the time of arrival values, wherein the one or more determined respective timing offset values may comprise the determined relative timing offset values.

The means may be further configured to perform: determining a random access preamble associated with at least one of the plurality of downlink resources; and transmitting the determined random access preamble.

A processor, memory, and/or example algorithms (which may be encoded as instructions, program, or code) may be provided as example means for providing or causing performance of operation. In accordance with one example embodiment, a non-transitory computer-readable medium comprising instructions stored thereon which, when executed with at least one processor, cause the at least one processor to: cause receiving of a plurality of downlink resources; determine one or more respective timing offset values, wherein respective ones of the one or more respective timing offset values may be associated with different respective ones of the plurality of downlink resources; generate a report based, at least partially, on the one or more determined respective timing offset values; and cause transmitting of the report to the network.

In accordance with another example embodiment, a non-transitory program storage device readable by a machine may be provided, tangibly embodying instructions executable by the machine for performing operations, the operations comprising: cause receiving of a plurality of downlink resources; determine one or more respective timing offset values, wherein respective ones of the one or more respective timing offset values may be associated with different respective ones of the plurality of downlink resources; generate a report based, at least partially, on the one or more determined respective timing offset values; and cause transmitting of the report to the network.

In accordance with another example embodiment, a non-transitory computer-readable medium comprising instructions that, when executed by an apparatus, cause the apparatus to perform at least the following: receiving a plurality of downlink resources; determining one or more respective timing offset values, wherein respective ones of the one or more respective timing offset values may be associated with different respective ones of the plurality of downlink resources; generating a report based, at least partially, on the one or more determined respective timing offset values; and transmitting the report to the network.

A computer implemented system comprising: at least one processor and at least one non-transitory memory storing instructions that, when executed by the at least one processor, cause the system at least to perform: receiving a plurality of downlink resources; determining one or more respective timing offset values, wherein respective ones of the one or more respective timing offset values may be associated with different respective ones of the plurality of downlink resources; generating a report based, at least partially, on the one or more determined respective timing offset values; and transmitting the report to the network.

A computer implemented system comprising: means for receiving a plurality of downlink resources; means for determining one or more respective timing offset values, wherein respective ones of the one or more respective timing offset values may be associated with different respective ones of the plurality of downlink resources; means for generating a report based, at least partially, on the one or more determined respective timing offset values; and means for transmitting the report to the network.

In accordance with one example embodiment, an apparatus may comprise: at least one processor; and at least one memory storing instructions that, when executed by the at least one processor, cause the apparatus at least to: receive, from a user equipment, a report; determine one or more timing advance values associated with respective ones of a plurality of corresponding downlink resources based, at least partially, on the report; and transmit, to the user equipment, at least one of the one or more determined timing advance values.

The report may comprise a timing advance refinement report.

The example apparatus may be further configured to: receive, from the user equipment, at least one uplink message transmitted with the at least one of the one or more determined timing advance values.

The plurality of corresponding downlink resources may comprise at least one of: a plurality of downlink reference signals, a plurality of synchronization signal block resources, downlink resources indicated by a plurality of joint downlink and uplink transmission configuration indicator states, downlink resources indicated by a plurality of downlink transmission configuration indicator states, or downlink resources indicated by a plurality of uplink transmission configuration indicator states.

The report may comprise at least one of: an indication of a timing offset value associated with at least one anchor resource, an indication of one or more relative timing offset values, an indication of one or more absolute timing offset values, a single timing offset value for simultaneous uplink transmission with at least two of a plurality of transmission and reception points, an indication of a timing offset value associated with a downlink resource or resources having signal quality equal to or higher than a received power threshold, an indication of a timing offset value associated with a downlink resource or resources within a timing offset window, or an indication of a timing offset value that is a candidate timing advance value for uplink transmission.

The example apparatus may be further configured to: transmit, to the user equipment, an indication to perform measurements for generation of the report, wherein the indication may comprise at least one of: one or more identifiers of the plurality of corresponding downlink resources, or an identifier of at least one reference resource of the plurality of corresponding downlink resources, wherein the indication may comprise at least one of: a medium access control element, a radio resource control downlink control information, or a physical layer control information.

The example apparatus may be further configured to: receive, from the user equipment, a random access preamble associated with at least one of the plurality of corresponding downlink resources; and transmit, to the user equipment, the at least one of the one or more determined timing advance values in response to the received random access preamble.

In accordance with one aspect, an example method may be provided comprising: receiving, from a user equipment, a report; determining one or more timing advance values associated with respective s of a plurality of corresponding downlink resources based, at least partially, on the report; and transmitting, to the user equipment, at least one of the one or more determined timing advance values.

The example method may further comprise: receiving, from the user equipment, at least one uplink message transmitted with the at least one of the one or more determined timing advance values. The plurality of corresponding downlink resources may comprise at least one of: a plurality of downlink reference signals, a plurality of synchronization signal block resources, downlink resources indicated by a plurality of joint downlink and uplink transmission configuration indicator states, downlink resources indicated by a plurality of downlink transmission configuration indicator states, or downlink resources indicated by a plurality of uplink transmission configuration indicator states.

The report may comprise at least one of: an indication of a timing offset value associated with at least one anchor resource, an indication of one or more relative timing offset values, an indication of one or more absolute timing offset values, a single timing offset value for simultaneous uplink transmission with at least two of a plurality of transmission and reception points, an indication of a timing offset value associated with a downlink resource or resources having signal quality equal to or higher than a received power threshold, an indication of a timing offset value associated with a downlink resource or resources within a timing offset window, or an indication of a timing offset value that is a candidate timing advance value for uplink transmission.

The example method may further comprise: transmitting, to the user equipment, an indication to perform measurements for generation of the report, wherein the indication may comprise at least one of: one or more identifiers of the plurality of corresponding downlink resources, or an identifier of at least one reference resource of the plurality of corresponding downlink resources, wherein the indication may comprise at least one of: a medium access control element, a radio resource control downlink control information, or a physical layer control information.

The example method may further comprise: receiving, from the user equipment, a random access preamble associated with at least one of the plurality of corresponding downlink resources; and transmitting, to the user equipment, the at least one of the one or more determined timing advance values in response to the received random access preamble.

In accordance with one example embodiment, an apparatus may comprise: circuitry configured to perform: receiving, from a user equipment, a report; circuitry configured to perform: determining one or more timing advance values associated with respective ones of a plurality of corresponding downlink resources based, at least partially, on the report; and circuitry configured to perform: transmitting, to the user equipment, at least one of the one or more determined timing advance values.

In accordance with one example embodiment, an apparatus may comprise: processing circuitry; memory circuitry including computer program code, the memory circuitry and the computer program code configured to, with the processing circuitry, enable the apparatus to: receive, from a user equipment, a report; determine one or more timing advance values associated with respective ones of a plurality of corresponding downlink resources based, at least partially, on the report; and transmit, to the user equipment, at least one of the one or more determined timing advance values.

In accordance with one example embodiment, an apparatus may comprise means for performing: receiving, from a user equipment, a report; determining one or more timing advance values associated with respective ones of a plurality of corresponding downlink resources based, at least partially, on the report; and transmitting, to the user equipment, at least one of the one or more determined timing advance values.

The means may be further configured to perform: receiving, from the user equipment, at least one uplink message transmitted with the at least one of the one or more determined timing advance values.

The plurality of corresponding downlink resources may comprise at least one of: a plurality of downlink reference signals, a plurality of synchronization signal block resources, downlink resources indicated by a plurality of joint downlink and uplink transmission configuration indicator states, downlink resources indicated by a plurality of downlink transmission configuration indicator states, or downlink resources indicated by a plurality of uplink transmission configuration indicator states.

The report may comprise at least one of: an indication of a timing offset value associated with at least one anchor resource, an indication of one or more relative timing offset values, an indication of one or more absolute timing offset values, a single timing offset value for simultaneous uplink transmission with at least two of a plurality of transmission and reception points, an indication of a timing offset value associated with a downlink resource or resources having signal quality equal to or higher than a received power threshold, an indication of a timing offset value associated with a downlink resource or resources within a timing offset window, or an indication of a timing offset value that is a candidate timing advance value for uplink transmission.

The means may be further configured to perform: transmitting, to the user equipment, an indication to perform measurements for generation of the report, wherein the indication may comprise at least one of: one or more identifiers of the plurality of corresponding downlink resources, or an identifier of at least one reference resource of the plurality of corresponding downlink resources, wherein the indication may comprise at least one of: a medium access control element, a radio resource control downlink control information, or a physical layer control information.

The means may be further configured to perform: receiving, from the user equipment, a random access preamble associated with at least one of the plurality of corresponding downlink resources; and transmitting, to the user equipment, the at least one of the one or more determined timing advance values in response to the received random access preamble.

In accordance with one example embodiment, a non-transitory computer-readable medium comprising instructions stored thereon which, when executed with at least one processor, cause the at least one processor to: cause receiving, from a user equipment, of a report; determine one or more timing advance values associated with respective ones of a plurality of corresponding downlink resources based, at least partially, on the report; and cause transmitting, to the user equipment, of at least one of the one or more determined timing advance values.

In accordance with another example embodiment, a non-transitory program storage device readable by a machine may be provided, tangibly embodying instructions executable by the machine for performing operations, the operations comprising: cause receiving, from a user equipment, of a report; determine one or more timing advance values associated with respective ones of a plurality of corresponding downlink resources based, at least partially, on the report; and cause transmitting, to the user equipment, of at least one of the one or more determined timing advance values.

In accordance with another example embodiment, a non-transitory computer-readable medium comprising instructions that, when executed by an apparatus, cause the apparatus to perform at least the following: receiving, from a user equipment, a report; determining one or more timing advance values associated with respective ones of a plurality of corresponding downlink resources based, at least partially, on the report; and transmitting, to the user equipment, at least one of the one or more determined timing advance values.

A computer implemented system comprising: at least one processor and at least one non-transitory memory storing instructions that, when executed by the at least one processor, cause the system at least to perform: receiving, from a user equipment, a report; determining one or more timing advance values associated with respective ones of a plurality of corresponding downlink resources based, at least partially, on the report; and transmitting, to the user equipment, at least one of the one or more determined timing advance values.

A computer implemented system comprising: means for receiving, from a user equipment, a report; means for determining one or more timing advance values associated with respective ones of a plurality of corresponding downlink resources based, at least partially, on the report; and means for transmitting, to the user equipment, at least one of the one or more determined timing advance values.

The term “non-transitory,” as used herein, is a limitation of the medium itself (i.e. tangible, not a signal) as opposed to a limitation on data storage persistency (e.g., RAM VS. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1-17. (canceled)

18. An apparatus comprising at least one processor; and at least one memory storing instructions that, when executed by the at least one processor, cause the apparatus at least to:
receive a plurality of downlink resources;
determine one or more respective timing offset values, wherein respective ones of the one or more respective timing offset values are associated with different respective ones of the plurality of downlink resources;
generate a report based, at least partially, on the one or more determined respective timing offset values; and
transmit the report to the network.

19. The apparatus of claim 18, wherein the plurality of downlink resources are respectively associated with respective ones of a plurality of transmission and reception points of the network.

20. The apparatus of claim 18, wherein the apparatus is further caused to:
receive one or more timing advance values.

21. The apparatus of claim 20, wherein the apparatus is further caused to:
receive the one or more timing advance values in response to the transmitted report.

22. The apparatus of claim 20, wherein the apparatus is further caused to:
transmit, to the network, at least one uplink message using at least one of the one or more timing advance values.

23. The apparatus of claim 18, wherein the apparatus is further caused to:
determine at least one first timing offset value associated with a first downlink reference signal associated with one of the plurality of downlink resources; and
determine at least one second timing offset value associated with a second downlink reference signal associated with another one of the plurality of downlink resources.

24. The apparatus of claim 23, wherein the apparatus is further caused to:
include an indication of the at least one first timing offset value and an indication of the at least one second timing offset value in the report.

25. The apparatus of claim 23, wherein at least one of: the at least one first timing offset value, or the at least one second timing offset value comprises a candidate timing advance value for uplink transmission.

26. The apparatus of claim 18, wherein the plurality of downlink resources comprises at least one anchor resource, and wherein the apparatus is further caused to:
determine respective relative timing offset values for the respective ones of the plurality of downlink resources relative to a timing offset value associated with the at least one anchor resource, wherein the respective relative timing offset values are associated with a first path of one or more power delay profiles associated with the plurality of downlink resources, wherein the first path is above a configured power threshold;
determine or more of the respective relative timing offset values that are within a timing window; and
generate the report based, at least partially, on the timing offset value associated with the at least one anchor resource, and the determined one or more of the respective relative timing offset values.

27. The apparatus of claim 18, wherein the one or more determined respective timing offset values comprise one or more absolute timing offset values.

28. The apparatus of claim 18, wherein the report comprises an indication of a single timing offset value for simultaneous uplink transmission associated with at least two of the plurality of downlink resources, wherein the single timing offset value is at least one of:
a timing offset value associated with a downlink resource or resources, a timing offset value associated with a downlink resource or resources having signal quality equal to or higher than a received power threshold, or a timing offset value associated with a downlink resource or resources within a timing offset window.

29. The apparatus of claim 18, wherein the apparatus is further caused to:
receive an indication of at least one of: the plurality of downlink resources, or at least one reference resource of the plurality of downlink resources, wherein the indication comprises at least one of: a medium access control element, a radio resource control downlink control information, or a physical layer control information.

30. The apparatus of claim 18, wherein the apparatus is further caused to:
determine channel estimates for respective ones of the plurality of downlink resources;
determine time of arrival values based, at least partially, on the determined channel estimates, wherein the determined time of arrival values comprise values that are at least one of:
equal to or above at least one of: a noise floor, or a received power threshold; and
determine relative timing offset values between selected ones of the time of arrival values, wherein the one or more determined respective timing offset values comprises the determined relative timing offset values.

31. The apparatus of claim 18, wherein the apparatus is further caused to:
determine a random access preamble associated with at least one of the plurality of downlink resources; and
transmit the determined random access preamble.

32. A method comprising:
receiving, with a user equipment, a plurality of downlink resources;
determining one or more respective timing offset values, wherein respective ones of the one or more respective timing offset values are associated with different respective ones of the plurality of downlink resources;
generating a report based, at least partially, on the one or more determined respective timing offset values; and
transmitting the report to a network.

33. An apparatus comprising at least one processor; and at least one memory storing instructions that, when executed by the at least one processor, cause the apparatus at least to:
receive, from a user equipment, a report;
determine one or more timing advance values associated with respective ones of a plurality of corresponding downlink resources based, at least partially, on the report; and
transmit, to the user equipment, at least one of the one or more determined timing advance values.
